(19) United States
(12) Patent Application Publication
(10) Pub. No.: US 2019/0135260 A1
(43) Pub. Date: May 9, 2019

(54) BRAKE-BLEEDING DEVICE AND RELATED METHODS

(71) Applicant: Ryan Graves, Paso Robles, CA (US)

(72) Inventor: Ryan Graves, Paso Robles, CA (US)

(21) Appl. No.: 15/802,882

(22) Filed: Nov. 3, 2017

(51) Int. Cl. B60T 17/22

(52) U.S. Cl. CPC B60T 17/223

(57) ABSTRACT

A device and related methods for bleeding the brake system of a vehicle without the need for two people to participate in the operation. The device allows a single user to remotely control an adjustable support which extends to fit between the steering wheel and brake pedal of the vehicle, with an actuation system operable to depress and release the brake pedal while the user is positioned at a brake line valve of the vehicle. The device can be used for remotely depressing a brake pedal of a vehicle in order to bleed the hydraulic brake system, check the brake light function, flushing the brake fluid, or air brake diagnoses to check for air leaks and function.

### FIELD OF THE INVENTION

The present invention relates to bleeding of hydraulic brake systems. Specifically, the present invention relates to a device for bleeding a hydraulic brake system without the need for two people to participate in the operation.

### DISCUSSION OF THE BACKGROUND

Most vehicles on the road today have a hydraulic braking system including brake pads, calipers, and a closed system of pressurized inelastic brake fluid which must be free of air bubbles in order to function properly. The brake pads have to be replaced from time to time when they become worn down, which requires the calipers to be removed and their cylinders to be compressed in order to make room for the new, thicker brake pads. The calipers themselves also sometimes need to be replaced, which requires the brake fluid lines to be transferred from the old caliper to the new caliper. Both of these processes often introduce air bubbles into the brake fluid lines, which then must be bled in order to remove the bubbles and maintain optimal braking function. Bleeding the brake fluid lines requires the brake pedal in the cabin of the vehicle to be depressed, while the brake line valve at the wheel is monitored and capped after removal of air bubbles.

This practice has traditionally required one person to be in the cabin of the vehicle to depress the brake pedal and another person at a wheel to monitor and cap the brake line valve. Thus, a car owner maintaining his or her own vehicle typically cannot change their brake pads or calipers without asking for help. Likewise, a vehicle repair or maintenance shop typically must devote the labor of two employees to this process, doubling the expense for this part of a brake job.

Therefore, what is needed is a device which allows a single person performing a brake-bleeding operation to both control the depression and release of the brake pedal in the cabin of the vehicle, and monitor and cap the brake line valve at the wheel once air bubbles have been removed from the brake system.

### SUMMARY OF THE INVENTION

The present invention provides a device and related methods for remotely depressing a brake pedal of a vehicle in order to bleed the hydraulic brake system, check the brake light function, flushing the brake fluid, or air brake diagnoses to check for air leaks and function. The brake-bleeding device may apply pressure adequate to depress the brake pedal, thus pressurizing the brake fluid within the system. The brake-bleeding device may also be remotely controlled, allowing the device to be operated by a single person positioned at a brake line valve of the vehicle. The brake-bleeding device offers significant advancements in allowing a single person to control the depression and release of the brake pedal in the cabin of the vehicle, while monitoring the brake line valve at the wheel of the vehicle for air bubbles. The break-bleeding device may include an adjustable support, a wheel mount, a pedal mount, an automated actuation system, a remote control system, and a power system. A method of using the brake-bleeding device may include the steps of: attaching the wheel mount on the steering wheel of the vehicle, adjusting the length of the adjustable support, attaching the pedal mount to the brake pedal of the vehicle, connecting the pneumatic system to a compressed air source, connecting the power system to a power source, causing the brake pedal to be depressed via the remote control system, and releasing the pressure on the brake pedal via the remote control system.

The adjustable support may include a first end and a second end, the first end being positioned near the steering wheel and the second end being positioned nearer the brake pedal when the brake-bleeding device is installed in a vehicle. The adjustable support may also have a first arm and a second arm, the second arm being slidably fitted within the first arm at the first end such that the length of the adjustable support may be quickly adapted to fit the distance between the steering wheel and the brake pedal, and the second arm being secured in place in relation to the first arm by setting a position locking device such as a pin, spring-loaded button, or a clamp. The first arm may also support the pneumatic system at the second end. In some embodiments, the first arm may have a position locking hole, and the second arm may have multiple adjustment holes along its length. The length of the adjustable support may thereby be altered by sliding the second arm in or out of the first arm until an appropriate adjustment hole lines up with the position locking hole, and fitting the position locking device through both the position locking hole and the appropriate adjustment hole.

In other embodiments the adjustment holes may be located on the first arm, the position locking hole located on the second arm, and the position locking device may comprise a spring-loaded button within the position locking hole. The spring-loaded button may be operable to be pushed into the second arm in order to adjust the position of the second arm relative to the first arm, and slide out into an adjustment hole when the adjustment hole lines up with the position locking hole.

In some embodiments, the first arm may have an inner surface with at least one sliding channel and the second arm may have an outer surface with at least one sliding tab positioned lengthwise along the second arm, wherein the sliding tab fits into the sliding channel and prevents the second arm from twisting in relation to the first arm, thus assuring that the adjustment holes line up circumferentially with the position locking hole as the second arm slides into or out of the first arm.

In some embodiments, and without limitation, the first arm may include a joint (e.g., a pivoting or hinge joint) to accommodate vehicles that have bulky panels or structures below the steering column. The pivoting joint may allow the brake fluid bleeding device to be routed around the bulky panels of some vehicles without any impact on the effectiveness of the device. Pivoting joint may be located at various locations along the first arm, for example, at or near the wheel mount of the device near a distal end of the first arm.

The wheel mount may be attached at the first end of the adjustable support. In some embodiments, the wheel mount may be a ratchet style cinch device which is operable to loop around the steering wheel. In other embodiments, the wheel mount may be a rigid hook with a swinging arm, the wheel mount being operable to be quickly installed on the steering wheel by pushing the wheel mount—at the position of the swinging arm—against the steering wheel until the steering wheel is positioned inside the rigid hook and the swinging arm swings back into a closed position in contact with the rigid hook. In some embodiments, the swinging arm may be spring biased to close on the ratchet portion. In other embodiments, the swinging arm may swing outward, away from the first end of the adjustable support, while the rigid hook is installed on the steering wheel. The swinging arm may then be swung back into a closed position and held in place by a ridge on a lower extension of the rigid hook. The ratcheting clamp may be cinched down such that there is a tight fit on the steering wheel. The clamp may include a release mechanism, such as a release button. In other embodiments, the swinging arm may be an elastic extension of the rigid hook.

The interior surfaces of the clamp that interfaces with the steering wheel may be covered with a high friction surface, such as a knurled metal or plastic surface, or a tacky rubber surface to increase the coefficient of friction between the steering wheel and the clamp. For example, the high friction material may provide a static coefficient of friction in the range of 0.5 to 1.0.

In some embodiments, and without limitation, the wheel mount may include a laterally extending curved surface for creating more interfacing surface area with the steering wheel for a more stable interface. For example, the wheel mount may have flared lateral portions that have a curvature that is complementary to the circular curvature of the steering wheel.

The pedal mount may be attached to a distal end of the automated actuation system and secure the automated actuation system in position to depress the brake pedal of the vehicle. In some embodiments, the pedal mount may include a plate, a leg tip, and a hook and loop fastener, the plate being attached to the distal end of the automated actuation system, and supporting the leg tip and the hook and loop fastener. The hook and loop fastener may be a strap of sufficient length to wrap around the brake pedal, slide through a slot of the plate, and fold back against itself to be tightened and secured around the brake pedal. The pedal mount may comprise a commercially available hook and loop fastener such as a Velcro® strap. The leg tip may be attached to a bottom side of the plate and be operable to be secured against the brake pedal when the hook and loop fastener is in a secured position. In other embodiments, the pedal mount may include an adjustable bracket that can be adjusted to brake pedals of various sizes. For example, the vertical dimension of the face of the pedal may vary in its length and the pedal mount bracket may have two piece bracket that can be expanded or contracted by virtue of a sliding joint between the two pieces of the bracket. In some embodiments, the bracket may grip the back side of the pedal and the sliding joint may be lockable, such that no strap is needed to wrap around the pedal to secure it in place. In other example, the bracket may include a strap of sufficient length to wrap around the brake pedal, slide through a slot of the plate, and fold back against itself to be tightened and secured around the brake pedal, or a Velcro® strap.

The automated actuation system may be operable to extend the length of the brake-bleeding device may be a pneumatic actuator, a hydraulic cylinder, a traveling nut linear actuator, a traveling screw actuator, or a linear motor (e.g., a linear induction motor). In the case of a pneumatic actuator, the actuator may include a pneumatic cylinder, a pneumatic shaft, and a pneumatic control, the pneumatic control including an air input port and an air exhaust port. The air input port may be operable to connect to and receive air pressure from a compressed air source. In some embodiments, the air input port may comprise a standard male pneumatic connector. The pneumatic control may be in electronic communication with, and able to receive a command from, the remote control system. The pneumatic control may include an air valve, the air valve being operable to open or close the air input port and open or close the air exhaust port in accord with the command received from the remote control system. The air valve may comprise a commercially available three-way solenoid valve.

The pneumatic control may be in fluid communication with the pneumatic cylinder and be operable to direct air pressure into, or release air pressure from, the pneumatic cylinder. The pneumatic cylinder may house the pneumatic shaft in an air-tight and telescopic manner, such that the pneumatic shaft is operable to extend out of the pneumatic cylinder as air pressure is directed into the pneumatic cylinder via the pneumatic control, causing the pedal mount to apply pressure to the brake pedal of the vehicle. The pneumatic shaft may also be operable to retract back into the pneumatic cylinder as air pressure is released from the pneumatic cylinder via the pneumatic control, releasing pressure from the brake pedal.

The pneumatic system may further include an adjustable valve, the adjustable valve being operable to limit the flow of air moving between the pneumatic control and the pneumatic cylinder, thereby slowing the extension or retraction of the pneumatic shaft. The adjustable valve may be operable to be adjusted to increase or decrease the maximum flow of air moving between the pneumatic control and the pneumatic cylinder. The adjustable valve may include an adjusting screw, the maximum flow of air moving between the pneumatic control and the pneumatic cylinder being adjusted by turning the adjusting screw. In some embodiments, the adjustable valve may comprise a pneumatic governor.

The remote control system may include at least one remote controller with at least one remote control button, and a remote receiver capable of receiving a signal from the remote controller. The remote receiver may be located at the actuation system and be in electronic communication with an actuation controller, allowing a user to remotely operate the actuation system. The remote controller may be in wired or wireless electronic communication with the remote receiver. In some embodiments, the remote controller may comprise a remote fob including the at least one remote control button, and be in wireless electronic communication with the remote receiver via at least one remote control channel. A single remote control button may be used to operate the actuation system. In some examples, the pressing the remote control button may signal the pneumatic control, which may supply a voltage to a solenoid that opens a valve to allow compressor air into the pneumatic cylinder. After pressing the remote control button a single time, a constant voltage may be applied to the solenoid and pressure is constantly applied to the pedal. In such embodiments, pressing the remote control button a second time cuts the voltage applied by the pneumatic controller to the solenoid, and allow the air to leak out of the air cylinder. In other embodiments, the pressure applied by the brake-bleeding system may be variably controlled depending on how long the remote control button is depressed. A user may cause the pneumatic controller to open the air input port by holding the remote control button down for longer than an predetermined period of time (e.g., 0.5 seconds), and to open the air exhaust port by depressing the remote control button for less than the predetermined period of time.

The power system may be operable to provide power to each of the remote receiver and the pneumatic control. In some embodiments, the power system may be at least one battery, the at least one battery comprising at least one of a commercially available battery (e.g., an A, AA, or AAA battery, a C battery, a D battery, a 9-volt battery, or another similar commercially available battery for electronic devices). In other embodiments the power system may have an outlet plug. The outlet plug may be operable to plug into a wall outlet, or it may be operable to plug into the electrical system of the vehicle, comprising at least one of a cigarette lighter plug and a USB plug.

Several embodiments are discussed below, but the example embodiments shall not be interpreted as an exhaustive list. One with ordinary skill in the art will recognize that the scope of the present invention includes further variations and equivalents to the specific examples described herein.

In one aspect, the present invention relates to a device for bleeding a brake system of a vehicle, comprising: an adjustable support for changing the length of the device; a wheel mount for attaching the device to a steering wheel of the vehicle; a pedal mount for attaching the device to a brake pedal of the vehicle; a pneumatic system for applying pressure to the brake pedal; a remote control system for remotely operating the pneumatic system; and a power system. In some implementations, the adjustable support comprises a first arm and a second arm, the second arm being slidably fitted within the first arm. In some implementations, the first arm and second arm are secured together via a position locking device. In some implementations, the first arm comprises a locking hole, the second arm comprises a plurality of adjustment holes, and the position locking device comprises a pin. In some implementations, the first arm comprises an inner surface with at least one sliding channel and the second arm comprises an outer surface with at least one sliding tab positioned lengthwise along the second arm, wherein the sliding tab fits into the sliding channel and prevents the second arm from twisting in relation to the first arm. In some implementations, the wheel mount comprises a ratchet style cinch device. In some implementations, the wheel mount comprises a rigid hook with a swinging arm. In some implementations, the pedal mount comprises a hook and loop fastener. In some implementations, the pneumatic system comprises a pneumatic cylinder, a pneumatic shaft, and a pneumatic control, the pneumatic cylinder housing the pneumatic shaft in an air-tight telescopic manner. In some implementations, the pneumatic control comprises an air input port, an air exhaust port, and an air valve. In some implementations, the pneumatic control is in electronic communication with, and able to receive a command from, the remote control system. In some implementations, the pneumatic control comprises an air valve, the air valve being operable to open or close the air input port and open or close the air exhaust port in accord with the command received from the remote control system. In some implementations, the pneumatic system further comprises an adjustable valve, the adjustable valve being operable to limit the flow of air moving between the pneumatic control and the pneumatic cylinder. In some implementations, the remote control system comprises a remote controller with at least one remote control button, and a remote receiver capable of receiving a signal from the remote controller. In some implementations, the remote controller is in wireless electronic communication with the remote receiver via a remote control channel, the remote controller comprising a fob. In some implementations, the remote control button is operable to cause the fob to send a plurality of signals to the remote receiver, each signal in the plurality of signals being determined by the length of time the remote control button is depressed by a user. In some implementations, the power system comprises an outlet plug, the outlet plug being operable to plug into an electrical system of the vehicle. In some implementations, the outlet plug comprises at least one of a cigarette lighter plug and a USB plug.

In another aspect, the present invention relates to a method for using a device comprising an adjustable support for changing the length of the device, a wheel mount for attaching the device to a steering wheel of the vehicle, a pedal mount for attaching the device to a brake pedal of the vehicle, a pneumatic system for applying pressure to the brake pedal, a remote control system for remotely operating the pneumatic system, and a power system, the method comprising the steps of: attaching the wheel mount to the steering wheel of the vehicle; adjusting the length of the adjustable support by sliding the second arm in or out of the first arm and setting the position locking device; attaching the pedal mount to the brake pedal of the vehicle; plugging the power system into an electrical system of the vehicle; positioning a user at a brake line valve of the vehicle; and depressing the brake pedal of the vehicle via the remote control system. In some implementations the remote control system comprises a remote control button, the remote control button being operable to cause the pneumatic system to depress the brake pedal or release the brake pedal, depending on the length of time the remote control button is depressed, and further comprising the step of releasing the brake pedal via the remote control system.

In another aspect, a device for bleeding a brake system of a vehicle, comprising an adjustable support for changing the length of the device; a wheel mount for attaching the device to a steering wheel of the vehicle; a pedal mount for attaching the device to a brake pedal of the vehicle; an actuation system for extending the device to apply pressure to the brake pedal; and a remote control system for remotely operating the actuation system. The adjustable support may include a first arm and a second arm, the second arm being slidably fitted within the first arm. The first arm and second arm may be secured together via a position locking device wherein the body comprises a plurality of receivers for the position locking device and the position locking device is operable to engage the extension rod and any one of the plurality of receivers to hold the extension rod in a chosen position relative to the cavity. The wheel mount may include a ratcheting cuff operable to tightly lock onto portions of a steering wheel of various diameters and shapes. The first arm may include an inner surface with at least one sliding channel and the second arm comprises an outer surface with at least one sliding tab positioned lengthwise along the second arm, wherein the sliding tab fits into the sliding channel and prevents the second arm from twisting in relation to the first arm. The wheel mount may include a ratchet-style cinch device. The wheel mount may include a rigid hook with a swinging arm. The pedal mount may include a hook and loop fastener. The actuation system may include a pneumatic cylinder, a pneumatic shaft, and a pneumatic control, the pneumatic cylinder housing the pneumatic shaft in an air-tight and telescopic manner. The pneumatic control may include an air input port, an air exhaust port, and an air valve. The pneumatic control may be in electronic communication with, and able to receive a command from, the remote control system. The pneumatic control may include an air valve, the air valve being operable to open or close the air input port or to open or close the air exhaust port in accord with the command received from the remote control system. The pneumatic system may further includes an adjustable valve, the adjustable valve being operable to limit the flow rate of air moving between the pneumatic control and the pneumatic cylinder. The remote control system may include a remote controller with a remote control button, and a remote receiver capable of receiving a signal from the remote controller. The wheel mount may include a lateral curvature that complements the circular curvature of a steering wheel to create more interfacing surface area between the ratcheting cuff and the steering wheel. The pedal mount nay include an adjustable bracket structure that is operable to be fitted snugly over the face of the brake pedal for a secure engagement with brake pedals of various sizes. The second arm may include a pivoting joint therein to allow the device to avoid obstruction by a dash panel under a steering column of the vehicle or other structures within the vehicle. The wheel mount may include a material on a portion of the wheel mount that interfaces with the steering wheel, the material having a high coefficient of friction in contact with the steering wheel.

In another aspect, the present invention relates to a device for bleeding air from a hydraulic brake system of a vehicle, comprising an extendable body, the extendable body having an extension rod, a cavity therein for receiving the extension rod, wherein a position of the extension rod is adjustable within the cavity, and an arm extendable by a remotely activated actuator; a wheel mount for attaching the extendable body to a steering wheel of the vehicle; a pedal mount for attaching the extendable body to a brake pedal of the vehicle, wherein the arm is operable to be actuated to extend the extendable body to apply pressure to the brake pedal through the pedal mount. The remotely activated actuator may be a linear motor, a pneumatic air cylinder, a hydraulic cylinder, a traveling nut linear actuator, or a traveling screw actuator. The extension rod may include a pivoting joint therein to allow the device to avoid obstruction by a dash panel under a steering column of the vehicle or other structures within the vehicle. The wheel mount may include a ratcheting cuff operable to tightly lock onto portions of a steering wheel of various diameters and shapes. The wheel mount may include a material on a portion of the wheel mount that interfaces with the steering wheel, the material having a high coefficient of friction in contact with the steering wheel. The ratcheting cuff may include a lateral curvature that complements the circular curvature of a steering wheel to create more interfacing surface area between the ratcheting cuff and the steering wheel. The wheel mount may include a lateral curvature that complements the circular curvature of a steering wheel to create more interfacing surface area between the ratcheting cuff and the steering wheel. The wheel mount may include a material on a portion of the wheel mount that interfaces with the steering wheel, the material having a high coefficient of friction in contact with the steering wheel. The brake bleeding device may include an electronic remote control operable to activate the remotely activated actuator to extend or retract the arm by remote electromagnetic signal. The brake bleeding device a position locking device, wherein the extendable body comprises a plurality of receivers for the position locking device and the position locking device is operable to engage the extension rod and any one of the plurality of receivers to hold the extension rod in a chosen position relative to the cavity.

In another aspect, the present invention relates to a method draining brake fluid, comprising the steps of attaching a device having a wheel mount to the steering wheel of a vehicle; adjusting the length of the device by sliding a second arm into or out of a first arm and setting the position of the second arm relative to the first arm with a locking device; attaching a pedal mount of the device to a brake pedal of the vehicle; positioning a user at a brake line valve of the vehicle; and depressing the brake pedal of the vehicle by remotely activating an actuation system of the device. The remote control system may include a remote control button, the remote control button being operable to cause the pneumatic system to either depress the brake pedal or release the brake pedal, depending on the length of time the remote control button is depressed, and further comprising the step of releasing the brake pedal via the remote control system. The actuation system may be a linear motor, a pneumatic air cylinder, a hydraulic cylinder, a traveling nut linear actuator, or a traveling screw actuator. The second arm may include a pivoting joint therein to allow the device to avoid obstruction by a dash panel under a steering column of the vehicle or other structures within the vehicle. The wheel mount may include a ratcheting cuff operable to tightly lock onto portions of a steering wheel of various diameters and shapes. The wheel mount may include a material on a portion of the wheel mount that interfaces with the steering wheel, the material having a high coefficient of friction in contact with the steering wheel. The ratcheting cuff may include a lateral curvature that complements the circular curvature of a steering wheel to create more interfacing surface area between the ratcheting cuff and the steering wheel. The wheel mount may include a lateral curvature that complements the circular curvature of a steering wheel to create more interfacing surface area between the ratcheting cuff and the steering wheel. The wheel mount may include a material on a portion of the wheel mount that interfaces with the steering wheel, the material having a high coefficient of friction in contact with the steering wheel. The method may include using a brake bleeding device further comprising an electronic remote control operable to activate the remotely activated actuator to extend or retract the arm by remote electromagnetic signal. The method may include using a brake bleeding device further comprising a position locking device, wherein the extendable body comprises a plurality of receivers for the position locking device and the position locking device is operable to engage the extension rod and any one of the plurality of receivers to hold the extension rod in a chosen position relative to the cavity

It is an objective of the present invention to provide a device which allows a user who is bleeding the brake system of a vehicle to remotely operate a brake pedal of the vehicle while positioned at a wheel of the vehicle.

It is a further objective of the present invention to provide a device which allows a single person to perform a brake-bleeding operation on a vehicle.

It is a further objective of the present invention to provide a device which may be quickly adjusted to fit between the steering wheel and brake pedal of a plurality of different vehicles.

It is a further objective of the present invention to provide a device which may plug into the vehicle's electrical system, obviating the need to perform a brake bleeding operation in close proximity to an electrical wall outlet.

It is a further objective of the present invention to provide a device which depresses the brake pedal of a vehicle slowly and smoothly.

Additional aspects and objects of the invention will be apparent from the detailed descriptions and the claims herein.

### BRIEF DESCRIPTION OF THE DRAWINGS

FIG. 1 shows a perspective view of a brake-bleeding device, according to an embodiment of the present invention.

FIG. 2 shows a top-down cutout view of a brake-bleeding device, according to an embodiment of the present invention.

FIG. 3 shows a side cutout view of a brake-bleeding device, according to an embodiment of the present invention.

FIG. 4 shows a side view of a brake-bleeding device, according to an embodiment of the present invention.

FIG. 5 shows a block diagram of a brake-bleeding device, according to an embodiment of the present invention.

FIG. 6 shows a side view of a brake-bleeding device, according to an embodiment of the present invention.

FIG. 7 shows a perspective view of a wheel mount of a brake-bleeding device, according to an embodiment of the present invention.

FIG. 8 shows a perspective view of a wheel mount of a brake-bleeding device, according to an embodiment of the present invention.

FIG. 9 shows a perspective view of a wheel mount of a brake-bleeding device, according to an embodiment of the present invention.

FIG. 10A shows a perspective view of a pedal mount of a brake-bleeding device, according to an embodiment of the present invention.

FIG. 10B shows a perspective view of a pedal mount of a brake-bleeding device, according to an embodiment of the present invention.

FIG. 10C shows a perspective view of a pedal mount of a brake-bleeding device, according to an embodiment of the present invention.

### DETAILED DESCRIPTION OF THE EXEMPLARY EMBODIMENTS

Reference will now be made in detail to certain embodiments of the invention, examples of which are illustrated in the accompanying drawings. While the invention will be described in reference to these embodiments, it will be understood that they are not intended to limit the invention. Conversely, the invention is intended to cover alternatives, modifications, and equivalents that are included within the scope of the invention as defined by the claims. In the following disclosure, specific details are given as a way to provide a thorough understanding of the invention. However, it will be apparent to one skilled in the art that the present invention may be practiced without these specific details.

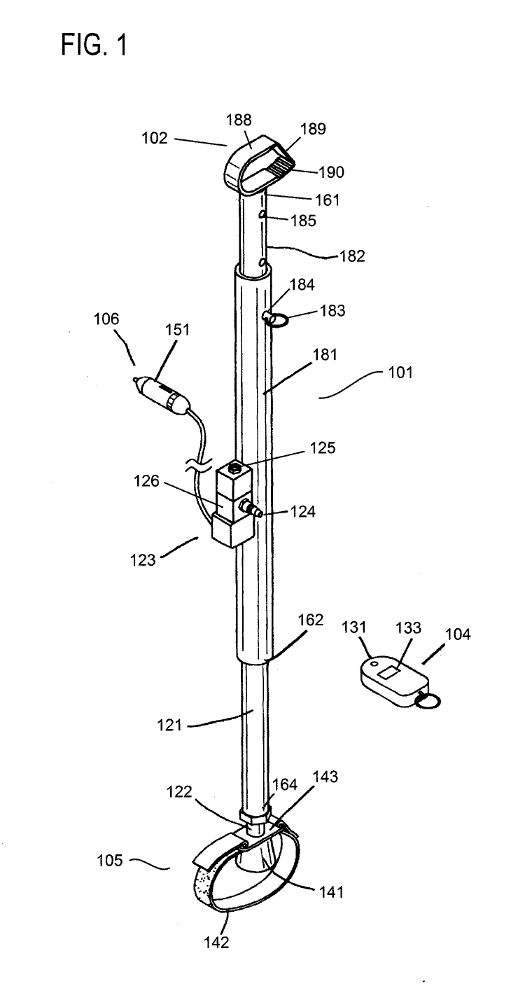

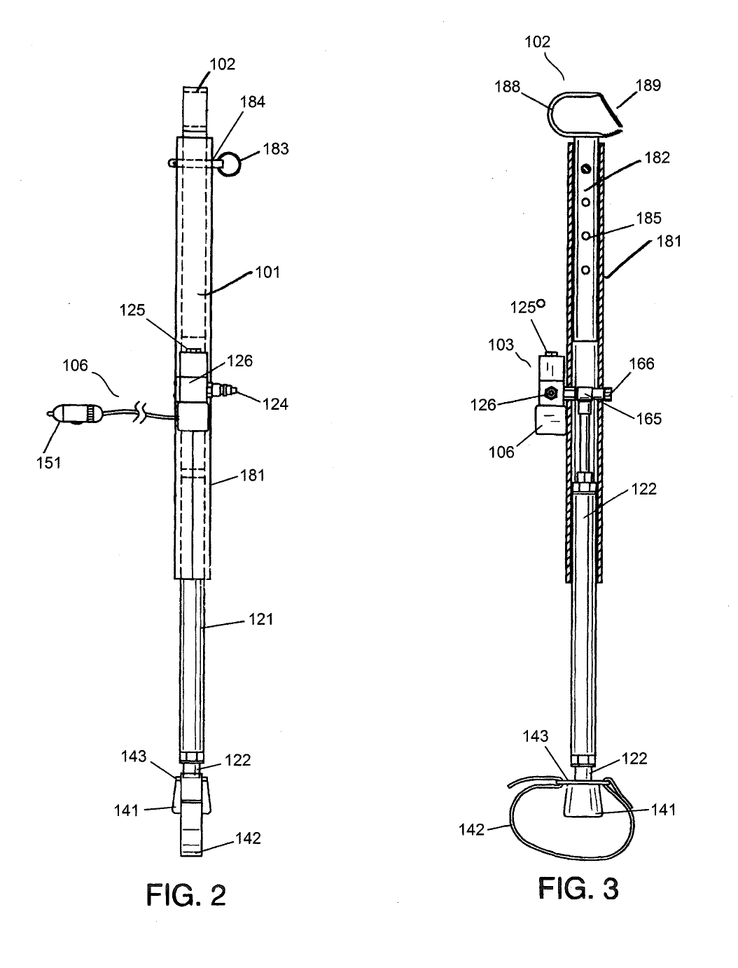

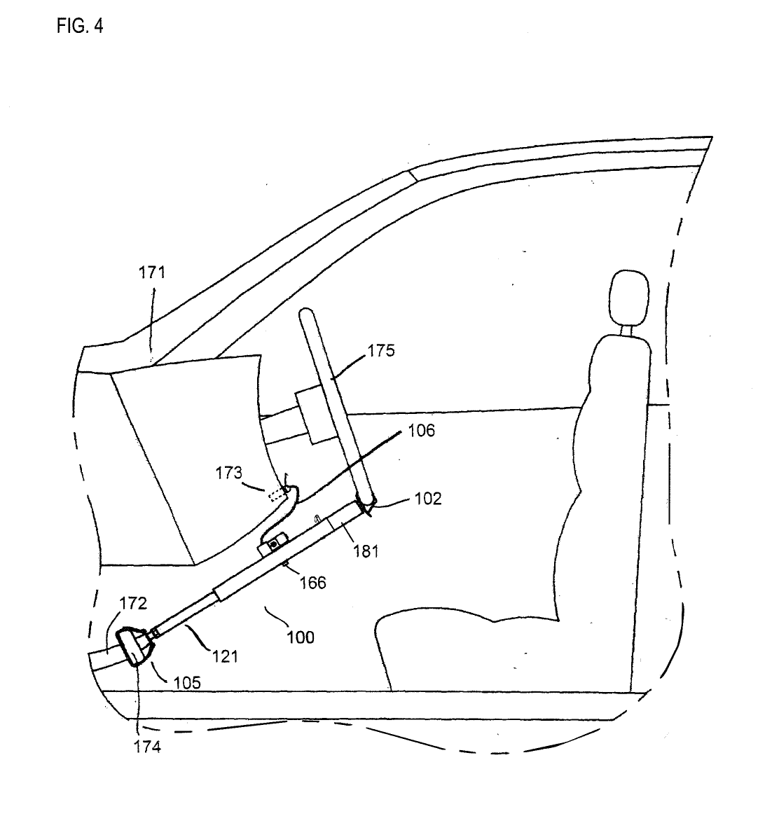

Referring to the drawings, wherein like reference characters designate like or corresponding parts throughout the several views, and referring particularly to FIGS. 1-5, it is seen that the present invention includes various embodiments of a break-bleeding device which may be remotely operated by a person positioned at a brake line valve of the vehicle, and methods of using the break-bleeding device.

Without limiting the invention, FIGS. 1-3 show a brake-bleeding device 100 according to an embodiment of the present invention. The brake-bleeding device 100 (hereinafter the “invention”) is configured for use with a hydraulic brake system 172 of a vehicle. The invention 100 comprises an adjustable support 101, a wheel mount 102, a pneumatic system 103, a remote control system 104, a pedal mount 105, and a power system 106.

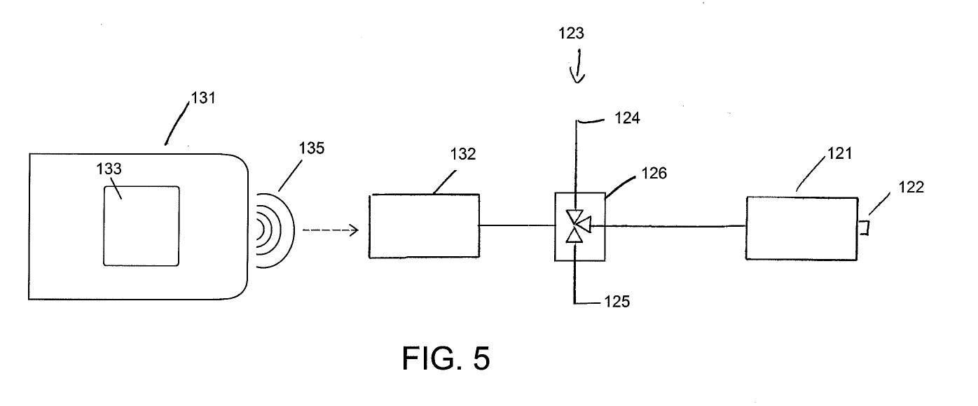

The adjustable support 101 may have a first end 161 and a second end 162, the first end 161 being near the steering wheel of the vehicle 171 and the second end being nearer to the brake pedal 174 of the vehicle 171 when the invention 100 is installed (see FIG. 4). The adjustable support 101 may also comprise a first arm 181 and a second arm 182, the second arm 182 being slidably fitted within the first arm 181 at the first end 161 such that the length of the adjustable support 101 may be quickly adjusted to fit the distance between the steering wheel 175 and the brake pedal 174, and the second arm 182 being secured in place in relation to the first arm 181 by setting a position locking device 183. The first arm 181 may also support the pneumatic system 103 at the second end 162. The first arm 181 has a position locking hole 184, and the second arm 182 has multiple adjustment holes 185 along its length. The length of the adjustable support 101 may thereby be altered by sliding the second arm 182 in or out of the first arm 181 until an appropriate adjustment hole 184 lines up with the position locking hole 185, and fitting the position locking device 183 through both the position locking hole 184 and the appropriate adjustment hole 185. The position locking device 183 may comprise pin.

The wheel mount 102 may be attached at the first end 161 of the adjustable support 101. The wheel mount 102 may comprise a rigid hook 188 with a swinging arm 189, the swinging arm 189 being operable to swing outward, away from the first end 161 of the adjustable support 101, while the rigid hook 188 is installed on the steering wheel 175 (see FIG. 4). The swinging arm 189 may then swing back into a closed position and be held in place by a ridge on a lower extension 190 of the rigid hook 188.

The pedal mount 105 may be attached to a distal end 164 of the pneumatic system 103 and secure the pneumatic system 103 in position to depress the brake pedal 174 of the vehicle 171. The pedal mount 105 may include a plate 143, a leg tip 141, and a hook and loop fastener 142, the plate 143 being attached to the distal end of the pneumatic system 103, and supporting the leg tip 141 and the hook and loop fastener 142. The hook and loop fastener 142 may comprise a strap of sufficient length to wrap around the brake pedal 174, slide through a slot of the plate 143, and fold back against itself. The pedal mount 105 may comprise a commercially available hook and loop fastener 142 such as a Velcro® strap. The leg tip 141 may be attached to a bottom side of the plate 143 and be operable to be secured against the brake pedal 174 when the hook and loop fastener 142 is in a secured position.

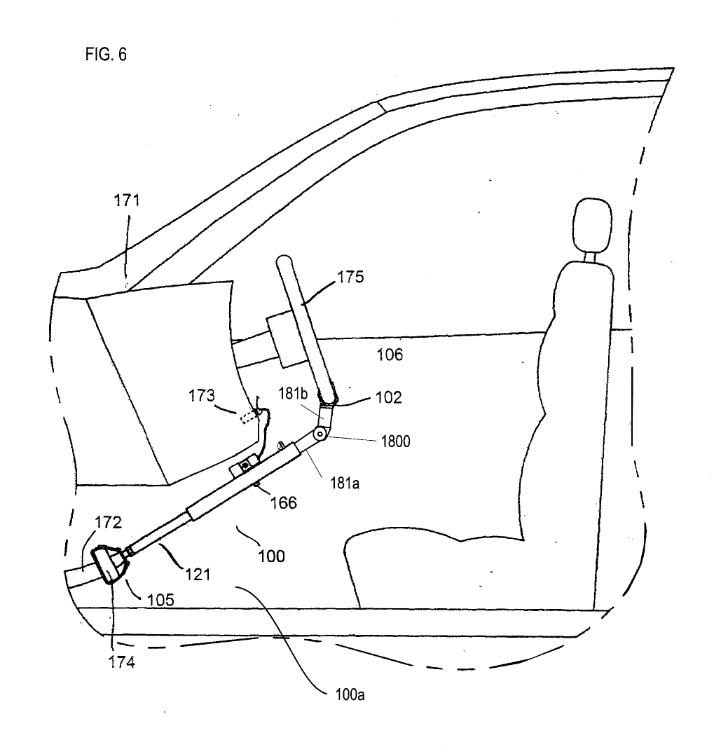

The pneumatic system 103 may be operable to extend the length of the brake-bleeding device and may comprise a pneumatic cylinder 121, a pneumatic shaft 122, and a pneumatic control 123, the pneumatic control 123 comprising an air input port 124 and an air exhaust port 125. The air input port 124 may be operable to connect to and receive air pressure from a compressed air source 128 (see FIG. 5). The air input port 124 may comprise a commercially available standard male pneumatic connector. The pneumatic control 123 may be in electronic communication with, and able to receive a command from, the remote control system 104. The pneumatic control 103 may further comprise an air valve 126, the air valve 126 being operable to open or close the air input port 124 and to open or close the air exhaust port 125 in accord with the command received from the remote control system 104. In some embodiments, the air valve 126 may comprise a commercially available three-way solenoid valve.

The pneumatic control 123 may be in fluid communication with the pneumatic cylinder 121 and be operable to direct air pressure into, or release air pressure from, the pneumatic cylinder 121. The pneumatic cylinder 121 may house the pneumatic shaft 122 in an air-tight and telescopic manner, such that the pneumatic shaft 122 is operable to extend out of the pneumatic cylinder 121 as air pressure is directed into the pneumatic cylinder 122 via the pneumatic control 123, causing the pedal mount 105 to apply pressure to the brake pedal 174 of the vehicle. The pneumatic shaft 122 may also be operable to retract back into the pneumatic cylinder 121 as air pressure is released from the pneumatic cylinder 121 via the pneumatic control 123, releasing pressure from the brake pedal 174.

The pneumatic system 103 may further include an adjustable valve 165, the adjustable valve 165 being operable to limit the flow of air moving between the pneumatic control 123 and the pneumatic cylinder 121, thereby slowing the extension or retraction of the pneumatic shaft 122. The adjustable valve 165 may be operable to be adjusted to increase or decrease the maximum flow of air moving between the pneumatic control 103 and the pneumatic cylinder 121. The adjustable valve 165 may include an adjusting screw 166, the maximum flow of air moving between the pneumatic control 103 and the pneumatic cylinder 121 being adjusted by turning the adjusting screw 166.

Referring now to FIG. 5, the remote control system 104 may include at least one remote controller 131 with at least one remote control button 133, and a remote receiver 132 capable of receiving a signal from the remote controller 131, the remote controller 104 being an electrical device that transmits a signal via a radio frequency link, the signal being used to direct the pneumatic control 123. The remote receiver 132 may be housed with and in electronic communication with the pneumatic control 103 and allow a user to remotely operate the pneumatic control 103. The remote controller 131 may be in wireless electronic communication with the remote receiver 132. The remote controller 131 may comprise a remote fob including the at least one remote control button 133, and be in wireless electronic communication with the remote receiver 132 via at least one remote control channel 135. The fob 131 is a handheld transmitter that comprises a remote control button 133.

In some embodiments, the remote control button 133 may be operable to cause the pneumatic control 103 to either open the air input port 124, or the air exhaust port 125, depending on how long the remote control button 133 is depressed. The remote receiver 132 is a receiver that communicates with the fob 131 using the remote control channel 135. The remote control channel 135 being a radio frequency link. The remote receiver 132 controls the operation of the air valve 126. The fob 131 may send a radio frequency control signal to the remote receiver 132. The remote control button 133 is a switch that is mounted on the fob 131. The actuation of the remote control button 133 may cause the fob 131 to establish the radio frequency link between the remote control button 133 and the remote receiver 132.

The remote receiver 132 is a radio-receiving device. The remote receiver 132 receives the signal from the fob 131 and, based on the signal, the remote receiver 132 may send a command to the pneumatic control 123 to change the position of the solenoid valve 126 from a closed position, to: 1) forming a fluidic connection between the compressed air source 128 and the pneumatic cylinder 121; or 2) forming a fluidic connection between the pneumatic cylinder 121 and the air exhaust port 125; and 3) moving back to a closed position. The remote control system 104 may comprise a commercially available 433 MHz remote control switch and receiver.

A user may cause the pneumatic control 103 to open the air input port 124 by depressing the remote control button 133 for longer than an predetermined period of time (e.g., 0.5 seconds), and close the air input port 124 by releasing the remote control button 133. The air exhaust port 125 may be opened by depressing the remote control button 133 for less than the predetermined period of time. Upon installation of the invention 100 in the vehicle 171, the first actuation of the remote control button 133 may be used to depress the brake pedal 174 in order to apply pressure to the hydraulic fluid of the vehicle brake system 172, and the second actuation of the remote control button 133 may be used to release pressure from the brake pedal 174 such that the resulting pumping action may subsequently be repeated.

The power system 106 may be operable to provide power to each of the remote receiver 132 and the pneumatic control 123. The power system 106 may comprise an outlet plug 151 and a power source housed near the remote receiver 132 and pneumatic control 123, the outlet plug 151 being operable to plug into the electrical system 173 of the vehicle 171, and comprising a cigarette lighter plug.

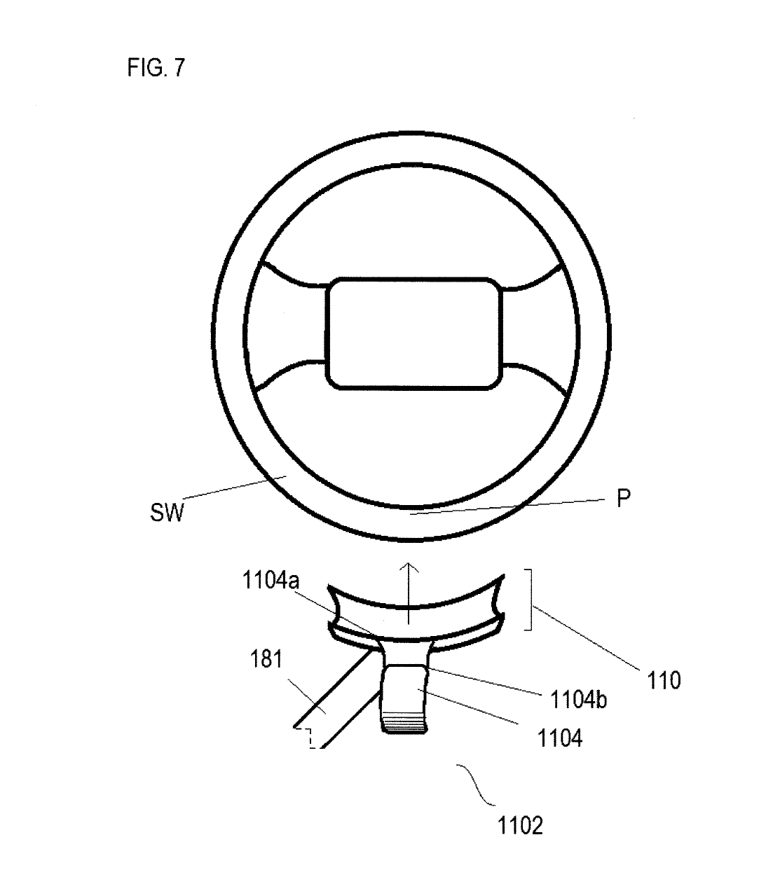

FIG. 6 shows a further exemplary embodiment of the brake-bleeding device according to the present invention. The brake bleeding device 100a shown in FIG. 6 includes the same or similar features to those shown in FIGS. 1-5, with the additional feature of a joint 1800 in the first arm 181. The brake-bleeding device 100a may include a first portion 181a and a second portion 181b of the first arm 181. The first portion 181a and the second 181b may be adjustably connected by the joint 1800 (e.g., a hinge joint) that can adjust the angle between the first portion 181a and the second portion 181b in order to accommodate vehicles that have bulky panels or structures below the steering column. The pivoting joint may allow the brake fluid bleeding device to be routed around the bulky panels of some vehicles without any impact on the effectiveness of the device.

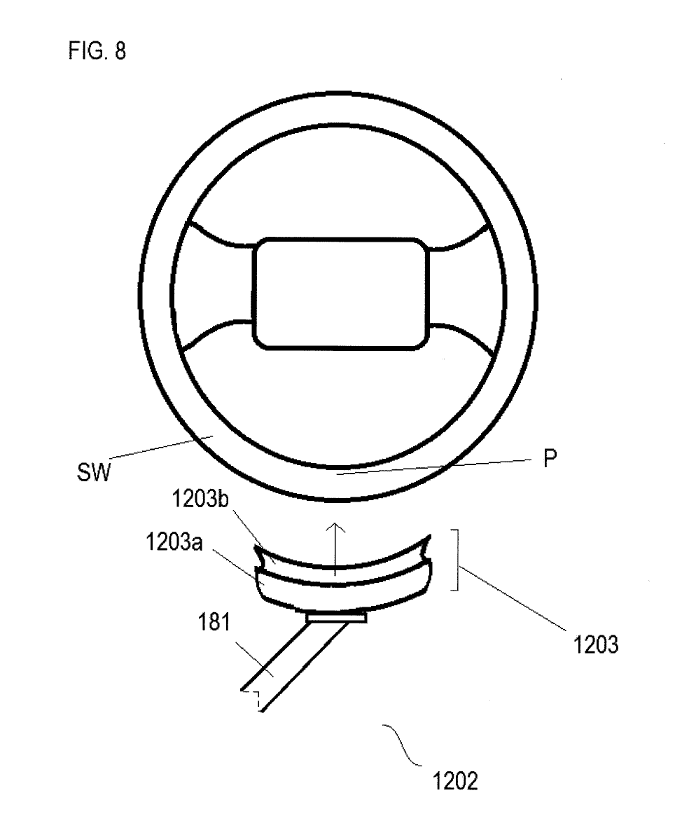

FIG. 7 shows an exemplary configuration of the wheel mount of the present invention. The wheel mount 1102 shown in FIG. 7 may include a laterally extending curved receiver 1103 for creating more interfacing surface area with the steering wheel SW for a more stable interface. The wheel mount 1102 may have flared lateral portions that have a curvature that is complementary to the circular curvature of the steering wheel SW. The wheel mount 1102 may also include a notched securing device 1104 that connects and interlocks with complementary notches on the backside of the receiver 1103. The notched securing device 1104 may have (1) a curved surface that interfaces with the superior portion of circumference of the steering wheel at point P and (2) flexing or pivoting joints 1104a and 1104b to allow the notched securing device 1104 to wrap around the circumference of the steering wheel at point P and provide a tight fit. In other examples, the wheel mount 1102 may have straps with buckle fasteners or hook and loop fasteners (Velcro®), or other fastening mechanisms that wrap around the steering wheel to secure the curved receiver 1103 to the steering wheel.

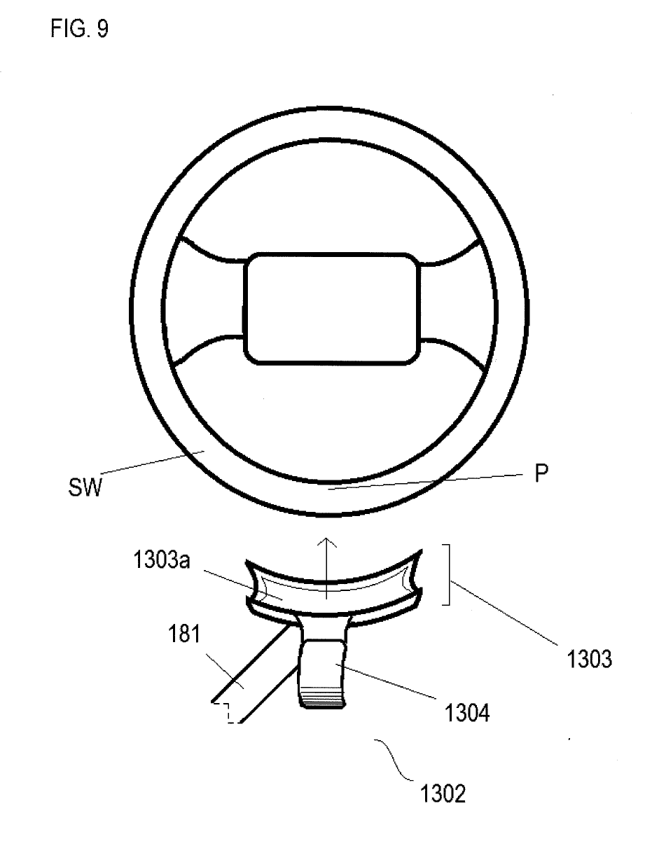

In still further examples, the wheel mount may not have a fastener that wraps around the steering wheel, and instead pressure fits onto the steering wheel. As shown in FIG. 8, without limiting the invention, the wheel mount 1202 may not include a part that folds or fits over the superior portion of steering wheel SW at point P. Instead, the curved sidewalls 1203a and 1203b may be resilient and flexible such that they be deformed to press the wheel mount 1202 onto the steering wheel SW at point P and the curved sidewalls 1203a and 1203b may then resile to their original shape to snugly grasp the circumference of the steering wheel SW. The sidewalls may be made from one or more resilient materials such as cross-linked polyethylene, polyvinyl chloride (PVC), spring steel, composites of such materials, and other appropriate materials.

FIG. 7 shows an exemplary configuration of the wheel mount of the present invention. The wheel mount 1102 shown in FIG. 7 may include a laterally extending curved receiver 1103 for creating more interfacing surface area with the steering wheel SW for a more stable interface. The wheel mount 1102 may have flared lateral portions that have a curvature that is complementary to the circular curvature of the steering wheel SW. The wheel mount 1102 may also include a notched securing device 1104 that connects and interlocks with complementary notches on the backside of the receiver 1103. The notched securing device 1104 may have (1) a curved surface that interfaces with the superior portion of circumference of the steering wheel at point P and (2) flexing or pivoting joints 1104a and 1104b to allow the notched securing device 1104 to wrap around the circumference of the steering wheel at point P and provide a tight fit. In other examples, the wheel mount 1102 may have straps with buckle fasteners or hook and loop fasteners (Velcro®), or other fastening mechanisms that wrap around the steering wheel to secure the curved receiver 1103 to the steering wheel.

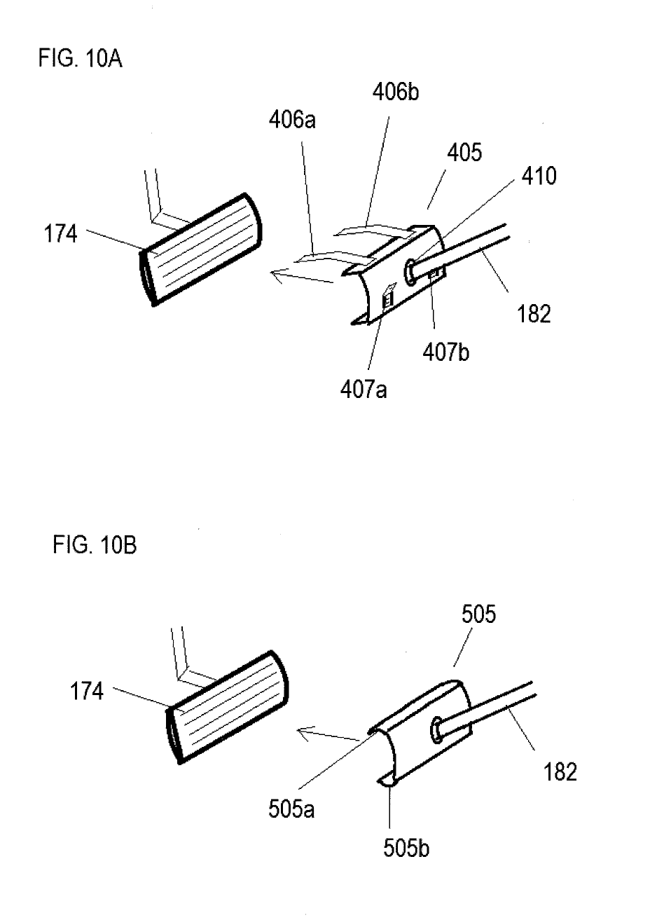

In some embodiments of the present invention, the interior surfaces of the wheel mount that interface with the steering wheel may be covered with a high friction surface, such as a knurled metal or plastic surface, or a tacky rubber surface to increase the coefficient of friction between the steering wheel and the wheel mount. For example, the high friction material may provide a static coefficient of friction in the range of 0.5 to 1.0. FIG. 9 shows an exemplary embodiment of the wheel mount of the present invention 1302 that includes a high friction surface 1303a lining the interior surface of the interfacing structure 1303. The high friction material may be, for example, a rubber or rubber foam comprising one or more of silicone rubber, nitrile rubber, butyl rubber natural rubber, ethylene propylene diene monomer (EPDM) rubber, polyurethane foam, ethylene-vinyl acetate (EVA) foam, polypropylene foam, and other appropriate materials.

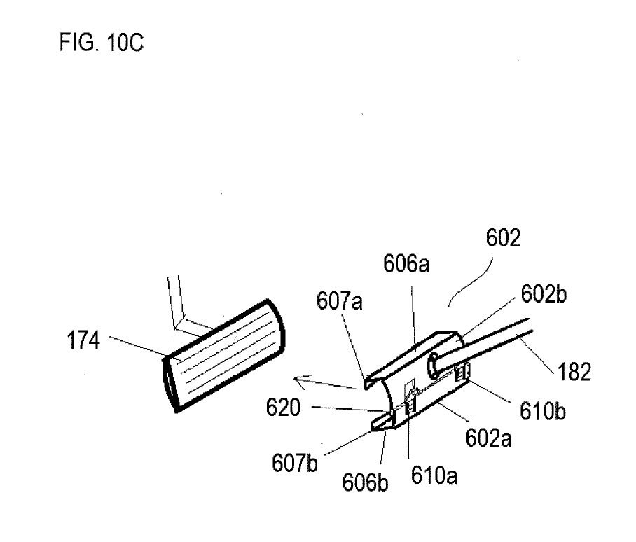

In some embodiments, the pedal mount may include a bracket for fitting over the brake pedal of the vehicle. As shown in FIG. 10A, the pedal mount 405 may have a bracket structure that reaches around the edges of the brake pedal 174. The pedal mount 405 may include straps 406a and 406b for wrapping around the backside of the brake pedal 174 to aid in securing the pedal mount 405, and the straps 406a and 406b may be secured around the brake pedal 174 with buckles 407a and 407b, respectively. The pedal mount 405 may also be secured to the second arm 182 by a movable joint, such as a ball and socket joint 410. The ball and socket joint 410 may have a limited range of motion (e.g., about 10° to about 20° relative to the central axis of the joint, such that the joint 410 allows some movement to accommodate vehicles of different designs and sizes, but not so much that the joint rotates to the point that it pedal mount rolls around the surface of the brake pedal when the second arm is actuated. The combination of the securing bracket and the joint 410 help the brake bleeding systems of the present invention to accommodate different shaped dashes and paneling within various vehicles while still maintaining a stable, firm connection between the pedal mount and the brake pedal.

In some embodiments, the pedal mount may have a bracket structure that may be pressure fit over the face of the brake pedal 174. As shown in FIG. 10B, the pedal mount 505 may have a bracket structure that reaches around the edges of the brake pedal 174. The pedal mount 505 may include firm, but resilient curved sidewalls 505a and 505b that can be deformed to press the pedal mount 505 onto the brake pedal 174 and the curved sidewalls 505a and 505b may then resile to their original shape to snugly grasp the top and bottom edges of the brake pedal 174. The sidewalls may be made from one or more resilient materials such as cross-linked polyethylene, polyvinyl chloride (PVC), spring steel, composites of such materials, and other appropriate materials.

In some embodiments, the pedal mount may include a bracket for fitting over the brake pedal of the vehicle that has an adjustable size. To accommodate the varying vertical dimension of brake pedals, some embodiments of the pedal mount may have a two piece bracket that can be expanded or contracted by virtue of a sliding joint between the two pieces of the bracket. In some embodiments, the bracket may grip the back side of the pedal and the sliding joint may be lockable, such that no strap is needed to wrap around the pedal to secure it in place. As shown in FIG. 10C, the pedal mount 605 may have a bracket structure that reaches around the edges of the brake pedal 174. The pedal mount 605 may include sidewalls 606a and 606b that include flanges 607a and 607b, respectively, for wrapping around the backside of the brake pedal 174 to aid in securing the pedal mount 605 to the brake pedal 174. The bracket 602 may include two pieces 602a and 602b that are slidable with respect to one another at joint 620. The two pieces 602a and 602b may be moved to expand or contract the pedal mount 602 to accommodate the vertical dimension of the brake pedal to which the pedal mount is attached. The pedal mount may include lockable sliding mechanisms 610a and 610b, which may be secured with latches once the pedal mount is properly fitted onto the brake pedal. The pedal mount 405 may also be secured to the second arm 182 by a movable joint, such as a ball and socket joint.

With respect to the above description, it is to be realized that the optimum dimensional relationship for the various components of the invention described above and in FIGS. 1 through 5 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

The present invention provides a device and related methods for remotely depressing a brake pedal of a vehicle in order to bleed the hydraulic brake system, check the brake light function, flushing the brake fluid, or air brake diagnoses to check for air leaks and function. It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

### Conclusion/Summary

The present invention provides a device and methods for bleeding the brake system of a vehicle without the need for two people to participate in the operation. It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

1. A device for bleeding a brake system of a vehicle, comprising:
a. an adjustable support for changing the length of the device;
b. a wheel mount for attaching the device to a steering wheel of the vehicle;
c. a pedal mount for attaching the device to a brake pedal of the vehicle;
d. an actuation system for extending said device to apply pressure to the brake pedal;
e. a remote control system for remotely operating the actuation system.

2. The device of claim 1, wherein the adjustable support comprises a first arm and a second arm, the second arm being slidably fitted within the first arm.

3. The device of claim 2, wherein the first arm and second arm are secured together via a position locking device wherein the body comprises a plurality of receivers for said position locking device and said position locking device is operable to engage said extension rod and any one of said plurality of receivers to hold said extension rod in a chosen position relative to said cavity.

4. The device of claim 3, wherein said wheel mount includes a ratcheting cuff operable to tightly lock onto portions of a steering wheel of various diameters and shapes.

5. (canceled)

6. The device of claim 1, wherein the wheel mount comprises a ratchet-style cinch device.

7. The device of claim 1, wherein the wheel mount comprises a rigid hook with a swinging arm.

8. (canceled)

9. The device of claim 1, wherein said actuation system comprises a pneumatic cylinder, a pneumatic shaft, and a pneumatic control, the pneumatic cylinder housing the pneumatic shaft in an air-tight and telescopic manner.

10. (canceled)

11. The device of claim 9, wherein the pneumatic control is in electronic communication with, and able to receive a command from, the remote control system.

12. The device of claim 9, wherein the pneumatic control comprises an air valve, the air valve being operable to open or close an air input port or to open or close an air exhaust port in accord with the command received from the remote control system.

13. The device of claim 9, wherein the pneumatic system further comprises an adjustable valve, the adjustable valve being operable to limit the flow rate of air moving between the pneumatic control and the pneumatic cylinder.

14. (canceled)

15. (canceled)

16. (canceled)

17. (canceled)

18. (canceled)

19. A device for bleeding air from a hydraulic brake system of a vehicle, comprising:
a. an extendable body, said extendable body having
i. an extension rod,
ii. a cavity therein for receiving said extension rod, wherein a position of said extension rod is adjustable within said cavity, and
iii. an arm extendable by a remotely activated actuator;
b. a wheel mount for attaching said extendable body to a steering wheel of the vehicle;
c. a pedal mount for attaching the extendable body to a brake pedal of the vehicle, wherein said arm is operable to be actuated to extend said extendable body to apply pressure to the brake pedal through said pedal mount.

20. (canceled)

21. (canceled)

22. The device of claim 19, wherein said wheel mount includes a ratcheting cuff operable to tightly lock onto portions of a steering wheel of various diameters and shapes.

23. (canceled)

24. (canceled)

25. (canceled)

26. (canceled)

27. The device of claim 19, further comprising an electronic remote control operable to activate the remotely activated actuator to extend or retract the arm by remote electromagnetic signal.

28. The device of claim 19, further comprising a position locking device, wherein the extendable body comprises a plurality of receivers for said position locking device and said position locking device is operable to engage said extension rod and any one of said plurality of receivers to hold said extension rod in a chosen position relative to said cavity.

29. A method draining brake fluid, comprising the steps of:
a. attaching a device having a wheel mount to the steering wheel of a vehicle;
b. adjusting the length of said device by sliding a second arm into or out of a first arm and setting the position of said second arm relative to said first arm with a locking device;
c. attaching a pedal mount of said device to a brake pedal of the vehicle;
d. positioning a user at a brake line valve of the vehicle; and
e. depressing the brake pedal of the vehicle by remotely activating an actuation system of said device.

30. The method of claim 30, wherein the remote control system comprises a remote control button, the remote control button being operable to cause the pneumatic system to either depress the brake pedal or release the brake pedal, depending on the length of time the remote control button is depressed, and further comprising the step of releasing the brake pedal via the remote control system.

31. The method of claim 30, wherein said actuation system is a linear motor, a pneumatic air cylinder, a hydraulic cylinder, a traveling nut linear actuator, or a traveling screw actuator.

32. (canceled)

33. The method of claim 30, wherein said wheel mount includes a ratcheting cuff operable to tightly lock onto portions of a steering wheel of various diameters and shapes.

34. (canceled)

35. (canceled)

36. (canceled)

36. (canceled)

38. The method of claim 30, further comprising an electronic remote control operable to activate the remotely activated actuator to extend or retract the arm by remote electromagnetic signal.

39. The method of claim 30, further comprising a position locking device, wherein the extendable body comprises a plurality of receivers for said position locking device and said position locking device is operable to engage said extension rod and any one of said plurality of receivers to hold said extension rod in a chosen position relative to said cavity.

40. (canceled)

41. (canceled)

42. (canceled)

43. (canceled)

44. (canceled)

45. (cancel
